(19) United States
(12) Patent Application Publication
(10) Pub. No.: US 2025/0157353 A1
(43) Pub. Date: May 15, 2025

(54) KNOWLEDGE-ENHANCED PROCEDURE PLANNING OF INSTRUCTIONAL VIDEOS USING KNOWLEDGE GRAPH AND LARGE LANGUAGE MODELS

(71) Applicant: NEC Laboratories America, Inc., Princeton, NJ (US)

(72) Inventors: Honglu Zhou, Menlo Park, CA (US); Renqiang Min, Princeton, NJ (US)

(21) Appl. No.: 18/944,762

(22) Filed: Nov. 12, 2024

Related U.S. Application Data
(60) Provisional application No. 63/598,255, filed on Nov. 13, 2023.

(51) Int. Cl. G09B 5/06; G09B 23/28

(52) U.S. Cl. CPC G09B 5/065; G09B 23/28

(57) ABSTRACT

Systems and methods include predicting a first action step and a last action step based on an initial visual observation and a goal visual state and retrieving multiple procedural plans from a procedural knowledge graph (PKG), trained using a set of training instructional videos, which start with the first action step and end with the last action step. A procedure plan is generated using the retrieved multiple procedural plans. An instructional video is generated based on the procedure plan.

### RELATED APPLICATION INFORMATION

This application claims priority to U.S. Provisional Patent Application No. 63/598,255 filed on Nov. 13, 2023, incorporated herein by reference in its entirety.

### BACKGROUND

### Technical Field

The present invention relates to artificial intelligence (AI) systems, and more particularly, to knowledge-enhanced procedure planning of instructional videos using a knowledge graph and large language models (LLM) to generate instructional videos.

### Description of the Related Art

Existing works have attained partial success in constructing a logical sequence of action steps by extensively leveraging various sources of information available in datasets. These sources can include heavy intermediate visual observations, procedural names, or natural language step-by-step instructions, for features or supervision signals for procedure planning models. However, the task remains formidable due to the implicit causal constraints in the sequencing of steps and the variability inherent in multiple feasible plans.

### SUMMARY

According to an aspect of the present invention, a computer-implemented method includes predicting a first action step and a last action step based on an initial visual observation and a goal visual state and retrieving multiple procedural plans from a procedural knowledge graph (PKG), trained using a set of training instructional videos, that start with the first action step and end with the last action step. A procedure plan is generated using the multiple procedural plans. An instructional video is generated based on the procedure plan.

According to another aspect of the present invention, a system includes a memory. The memory stores instructions. A processor is configured to execute the instructions to: access a procedural knowledge graph (PKG) constructed using a set of training instructional videos; predict a first action step and a last action step based on an initial visual observation and a goal visual state; retrieve multiple procedural plans from the PKG that start with the first action step and end with the last action step; generate a procedure plan using the multiple procedural plans retrieved from the PKG; and generate an instructional video based on the procedure plan.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures, wherein:

FIG. 1 is a block/flow diagram illustrating a system/method for generating a procedure plan employed in generating an instructional video, in accordance with an embodiment of the present invention;

FIG. 2 is a block/flow diagram illustrating in greater detail a system/method for generating a procedure plan employed in generating an instructional video, in accordance with an embodiment of the present invention;

FIG. 3 is a block/flow diagram illustrating in a computer system for generating an instructional video, in accordance with an embodiment of the present invention;

FIG. 4 is a block/flow diagram illustrating in a system/method for generating an instructional video, in accordance with an embodiment of the present invention; and

FIG. 5 is a flow diagram showing methods for generating an instructional video, in accordance with embodiments of the present invention.

### DETAILED DESCRIPTION OF PREFERRED EMBODIMENTS

In accordance with embodiments of the present invention, systems and methods are described that provide a capability of an agent to construct a logical sequence of action steps, thereby assembling a strategic procedural plan. This plan can be employed in navigating from an initial visual observation to a target visual outcome, as depicted in real-life instructional videos. Distinct from previous efforts that may not fully address these intricacies, the present embodiments employ only a minimal level of annotations for supervision that enhance the agent's capabilities in procedure planning for instructional videos by infusing the annotations with procedural knowledge. This knowledge, extracted from a Procedural Knowledge Graph built using the training instructional videos and augmented with insights from Large Language Models (LLMs), equips the agent to better navigate the complexities of step sequencing and its potential variations.

A Knowledge-Enhanced Procedure Planning (KEPP) system is provided that harnesses the power of both a Procedural Knowledge Graph and a Large Language Model. Procedure planning for instructional videos is a challenging task, primarily due to the complexity of capturing causal constraints in action sequencing and the variability inherent in generating multiple feasible plans. To address this challenge, a Procedural Knowledge Graph (PKG) is employed in accordance with embodiments of the present invention. PKG includes nodes that represent action steps within an instructional domain, and edges signify direct transitions between steps, incorporating their observed frequencies and empirical transition probabilities derived from real-world scenarios.

PKG selection is deliberate, as its graph structure inherently encodes step relationships, including causal constraints in the order of actions. Additionally, a graph structure is well-suited for capturing multiple sequences of action steps, enabling representation of various feasible plans effectively.

A PKG can be constructed by harnessing training data of a procedure, e.g., a medical procedure or mechanical procedure. The training data can include related instructional videos. Acting as an in-domain textbook, the PKG is further complemented by an LLM, which augments the system's knowledge with a broader range of procedural information, potentially extending beyond the specific training domain.

In KEPP, the system initiates by predicting a first action step and final action step based on the initial visual observation and a desired goal visual state, respectively. These predictions are employed to query the PKG, yielding multiple procedure plans that start and end with the specified actions. Various prompt templates can be employed to solicit additional procedure plans from the LLM, given the predicted start and end actions. Both the procedure plans obtained from the PKG and those generated by the LLM are deemed valuable suggestions for the procedure planning model. Consequently, they are incorporated as additional input conditions, enhancing the performance of the procedure planning model.

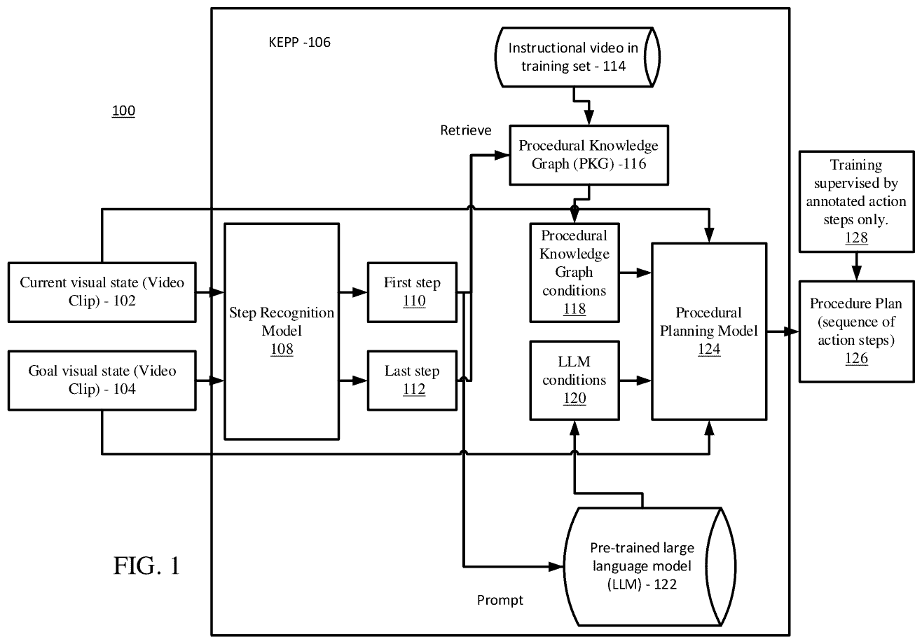

Referring now in detail to the figures in which like-numerals represent the same or similar elements and initially to FIG. 1, a system/method 100 for Knowledge-Enhanced Procedure Planning (KEPP) 106 is described and shown in accordance with embodiments of the present invention. The system/method 100 for KEPP 106 uses instructional videos, and leverages a Procedural Knowledge Graph (PKG) 116 and a Large Language Model 122 to construct a video instruction procedure for a specific task.

As an offline preprocessing step, PKG 116 is constructed using all the instructional videos in a training set. Given an initial (or current) visual observation 102 and a goal visual state 104, both in a format of video clips extracted from an instructional video, a step recognition model 108 is trained to predict a first step 110 and a last step 112 of a procedural plan in the video(s). The predictions of the first step 110 and last step 112 are utilized to retrieve multiple procedural plans that start and end with the specified action steps from the PKG 116. These procedural plans are called Procedural Knowledge Graph conditions 118.

The predictions of the first step 110 and last step 112 are also utilized to prompt the LLM 122 (or multiple LLMs) to produce additional procedural plans that start and end with the specified action steps. These procedural plans are called LLM conditions 120.

The initial visual observation 102, the goal visual state 104, Procedural Knowledge Graph conditions 118, and LLM conditions 120 are fed as input to a procedure planning model 124 in both training and testing (inferencing). The procedure planning model 124 predicts a procedure plan (e.g., a sequence of action steps) that facilitates the transition from the initial visual observation 102 towards achieving the desired goal state 104 for an instructional video. When training the procedure planning model 124, the annotated action steps are used as supervision signals 128.

KEPP 106 is an agent to construct a logical sequence of action steps to assemble a strategic procedural plan 126. This plan 126 is employed for navigating from the initial visual observation 102 to the target visual outcome 104, as depicted in real-life instructional videos.

The knowledge is sourced from training instructional videos and structured as a directed weighted graph that equips the agent (KEPP 106) to better navigate the complexities of step sequencing and its potential variations. KEPP 106 uses a probabilistic procedural knowledge graph extracted from the training instructional videos, effectively acting as a comprehensive textbook for the training domain. Experimental evaluations across, e.g., three datasets under settings of varying complexity reveal that KEPP attains superior, state-of-the-art results while requiring only minimal supervision.

A sequence of action steps of a strategic procedural plan can be employed in any application where a procedure is needed. Examples can include scenarios like repairing an automobile, baking a cake, a do-it-yourself construction project, medical procedures, and any other instructional video.

Understanding and interpreting nuanced actions demonstrated in videos is not merely a question of image recognition; it involves contextual understanding, sequence learning, and a degree of cognitive flexibility that is currently at the frontier of Artificial General Intelligence (AGI) research. The human brain is adept at decoding a sequence of movements, inferring intent, and extrapolating the steps needed to replicate a process. In contrast, for a machine learning model to achieve a similar level of understanding, it must be capable of processing temporal sequences, recognizing patterns within these sequences, and applying this knowledge to novel situations-skills that are still under development in the field of artificial intelligence (AI)

The agent (KEPP 106) has enhanced capabilities by infusing procedural knowledge. This knowledge, sourced from the training instructional videos and structured as a directed weighted graph, equips the agent to better navigate the complexities of step sequencing and its potential variations.

Procedure planning in instructional video tasks needs the agent to produce a sequence of action steps, thereby crafting a procedure plan that facilitates the transition from the initial visual observation 102 towards achieving the desired goal state 104 in unstructured real-life videos treating the sequence planning problem as a distribution-fitting problem.

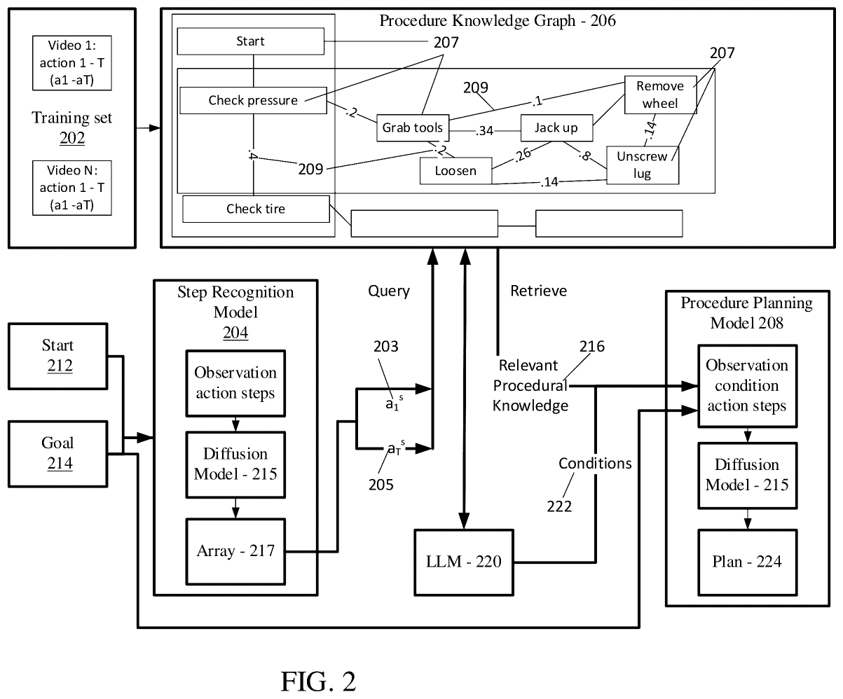

Referring to FIG. 2, the present embodiments will be described in greater detail. Given an initial visual observation state νₛₜₐᵣₜ and a visual goal state ν_{goal}, both are short video clips indicating different environment states extracted from an instructional video, a model is needed to plan a sequence of action steps a_{1:T} to reach the indicated goal. Here, T is a planning horizon, which corresponds to the number of action steps in the sequence produced by the model so that the environment state can be transformed from νₛₜₐᵣₜ to ν_{goal}. We use aₜ to denote the action step at the timestamp t, and in the following, νₛ and ν_{g} are short for νₛₜₐᵣₜ and ν_{goal}. Mathematically, the procedure planning problem can be defined as p(a_{1:T}|νₛ, ν_{g}) that denotes the conditional probability distribution of the action sequence a_{1:T} given the initial visual observation νₛₜₐᵣₜ and the goal visual state ν_{goal}.

Considering that the initial and final visual states are provided as input, resulting in reduced information uncertainty, predicting the initial and final action steps is more dependable than forecasting the intermediate ones, and consequently, an enhanced accuracy in predicting the first and final steps can lead to more effective procedure planning. Inspired by this, a procedure planning problem performed by a procedure planning model 208 is decomposed into two sub-problems, as shown in Eq. 1:

$$p ( {\hat{a}}_{1 : T} \vert {v}_{s} , {v}_{g} ) = p ( {\hat{a}}_{2 : T - 1} \vert {\hat{a}}_{1} , {\hat{a}}_{T} ) p ( {\hat{a}}_{1} , {\hat{a}}_{T} \vert {v}_{s} , {v}_{g} ) \qquad ( 1 )$$

where the first sub-problem is to identify the beginning step a₁ and the end step a_{T}, and the second sub-problem is to plan the intermediate action steps a_{2:T-1} given a₁ and a_{T}. âₜ is used to denote a predicted action step at timestamp t.

The present formulation differs in its approach to modeling the second sub-problem. Specifically, a conditioned projected diffusion model is used to jointly predict a_{2:T-1} at once, rather than rely on Transformer decoders to predict each intermediate action independently.

The second sub-problem is nontrivial even when armed with an oracle predictor for the first sub-problem. Procedure planning in real-life scenarios remains daunting due to at least the following challenges: (1) the presence of implicit temporal and causal constraints in the sequencing of steps, (2) the existence of numerous viable plans given an initial state and a goal state, and (3) the need to incorporate commonsense knowledge both in task-sharing steps and in managing the inherent variability in transition probabilities between steps.

Prior research attempted to address these challenges by extensively harnessing diverse sources of information found within the datasets. These sources include expensive annotations on intermediate visual observations, procedural task labels, and natural language step-by-step instructions, all of which are employed to augment input features or offer supervision signals. In contrast, the present embodiments harness a probabilistic PKG 206, which is extracted from the procedure plans in a training set 202. With the PKG 206, the procedure planning problem can be further decomposed to reduce its complexity and propose to the procedure planning model 208 (f:(νₛ, ν_{g}, T)→p(â_{1:T}|νₛ, ν_{g})) as follows:

$$p ( {\hat{a}}_{1 : T} \vert {v}_{s} , {v}_{g} ) = p ( {\hat{a}}_{1 : T} \vert {\hat{a}}_{1 : T} , {v}_{s} , {v}_{g} ) p ( {\hat{a}}_{1 : T} \vert {\hat{a}}_{1} , {\hat{a}}_{T} ) p ( {\hat{a}}_{1} , {\hat{a}}_{T} \vert {v}_{s} , {v}_{g} ) \qquad ( 2 )$$

where ã_{1:T} represents a graph path (e.g., a sequence of nodes) from PKG 206. This retrieved graph path provides a valuable procedure plan recommendation to the procedure planning model 208 aligned with the training domain, thus mitigating the complexity of procedure planning.

It is worth noting that the proposed approach to modeling procedure planning using Eq. 2 demands only a minimal level of supervision, specifically relying on the ground truth training procedure plans, which consist of sequences of action steps extracted from the training instructional videos. Eq. 2 circumvents the need for additional annotations, such as procedural task labels, step textual descriptions, or intermediate visual observations.

The probabilistic procedure knowledge graph 206 is extracted from the training set 202 of videos. Beginning step 203 and conclusion step 205 are identified according to an input initial state 212 and goal state 214; and then, conditioned on these steps and the planning horizon T, we query the graph 206 to retrieve relevant procedural knowledge 216 for knowledge enhanced procedure planning of instructional videos.

Given νₛₜₐᵣₜ (initial state 212) and ν_{goal} (initial state 214) as input, a step recognition model 204 can include a conditioned projected diffusion model 215 that is queried to identify the first action step 203 and the final step 205. This model 204 can also be referred to as a Step (Perception) Model.

The diffusion model 215 can be employed to tackle data generation by denoising and establishing the data distribution p(x₀) through a denoising Markov chain over variables {x_{N} . . . x₀}, starting with x_{N} as a Gaussian random distribution. In a forward diffusion phase, Gaussian noise ∈˜ [symbol] (0, I) is progressively added to the initial, unaltered data x₀, transforming it into a Gaussian random distribution. Each noise addition step can be mathematically defined as:

$${x}_{n} = \sqrt{{\overline{α}}_{n}} {x}_{0} + ε \sqrt{1 - {\overline{α}}_{n}} \qquad ( 3 )$$

$$q ( {x}_{n} \vert {x}_{n - 1} ) = 𝒩 ( {x}_{n} ; \sqrt{1 - {β}_{n}} {x}_{n - 1} , {β}_{n} I ) \qquad ( 4 )$$

where α̅ₙ=Πₛ₌₁ⁿ(1−βₛ) represents the noise magnitude, and {βₙ∈(0,1)}ₙ₌₁^{N} denotes the pre-defined ratio of Gaussian noise added in each step.

Conversely, the reverse denoising process transforms Gaussian noise back into a sample. Each denoising step can be mathematically defined as:

$${p}_{θ} ( {x}_{n - 1} \vert {x}_{n} ) = 𝒩 ( {x}_{n - I} ; {μ}_{θ} ( {x}_{n} , n ) , {\sum }_{θ} ( {x}_{n} , n ) ) \qquad ( 5 )$$

where μ_{θ} is parameterized as a learnable noise prediction model ∈_{θ}(xₙ, n), optimized using a mean-squared error loss L=∥∈−∈_{θ}(xₙ, n)∥², and Σ_{θ} is calculated using {βₙ}ₙ₌₁^{N}. During training, the model 215 selects a diffusion step n∈[1, N], calculates xₙ via Eq. 3, then the learnable model 215 estimates the noise and computes the loss based on the actual noise added at step n. After training, the diffusion model generates data akin to x₀ by iteratively applying the denoising process, starting from random Gaussian noise.

The Step (Perception) Model 204 includes a distribution that is to be fit as a two-action sequence [a₁, a_{T}], based on visual initial state 212 and goal states 214, νₛₜₐᵣₜ and ν_{goal}. These conditional visual states are concatenated with the actions along the action feature dimension, forming a multi-dimensional array 217:

$$[ \begin{matrix}{v}_{s} & 0 & … & 0 & {v}_{g} \\ {a}_{1} & 0 & … & 0 & {a}_{T}\end{matrix} ] \qquad ( 6 )$$

where the array is zero-padded to have a length that corresponds to the planning horizon T. During the denoising process, these conditional visual states can change, potentially misleading the learning process. To prevent this, a condition projection operation is applied, ensuring the visual state and zero-padding dimensions remain unchanged during training and inference.

The projection operation can be denoted as follows:

$$[ \begin{matrix}{\hat{v}}_{1} & {\hat{v}}_{2} & … & {\hat{v}}_{T - 1} & {\hat{v}}_{T} \\ {\hat{a}}_{1} & {\hat{a}}_{2} & … & {\hat{a}}_{T - 1} & {\hat{a}}_{T}\end{matrix} ] {\to }^{Projection} [ \begin{matrix}{v}_{s} & 0 & … & 0 & {v}_{g} \\ {\hat{a}}_{1} & 0 & … & 0 & {\hat{a}}_{T}\end{matrix} ] \qquad ( 7 )$$

where \hat{ν}t denotes the predicted visual state dimensions at timestamp t within the planning horizon T.

The PKG 206 is constructed using all the instructional videos in the training set 202. The PKG 206 includes nodes 207 that represent action steps within an instructional domain, and edges 209, which signify direct transitions between steps, including observed frequencies and empirical transition probabilities derived from real-world scenarios. Based on a query of the initial state 212 and the goal state 214, both in the format of short video clips extracted from an instructional video, the step recognition model 204, which has been trained with instructional videos, predicts the first step and last step of a procedural plan. The predictions of the first step and last step are utilized to retrieve multiple procedural plans that start and end with the specified action steps from the PKG 206. These procedural plans are called Procedural Knowledge Graph conditions 216. The predictions of the first step and last step are also utilized to prompt an LLM 220 (or multiple LLMs) to produce additional procedural plans that start and end with the specified action steps. These procedural plans are called LLM conditions 222.

The initial visual observation, the goal visual state, Procedural Knowledge Graph conditions, and LLM conditions are fed as input to the procedure planning model 208 in both training and testing. The procedure planning model 208 predicts a procedure plan 224 (e.g., a sequence of action steps) that facilitates the transition from the initial visual observation towards achieving the desired goal state in this instructional video. When training the procedure planning model, the annotated action steps are used as supervision signals.

By harnessing the power of the PKG and the LLM to generate informative procedure plan suggestions, the procedure planning model can more effectively learn and predict procedure plans. This, in turn, reduces the need for extensive supervision signals, enabling the training of the procedure planning model with minimal annotations. KEPP utilizes a procedural knowledge graph derived from the training instructional videos, acting as a textbook for the training domain, alongside the LLM, which contributes a broader range of procedural knowledge, potentially beyond the training domain.

The PKG encodes step relationships, including causal constraints in the order of action steps. Additionally, the PKG captures multiple sequences of action steps, enabling the representation of multiple feasible plans.

The LLM provides out-of-domain procedural knowledge, and through iterative prompting with thoughtfully crafted queries, can acquire additional potentially workable action plans.

By incorporating these procedure plan suggestions from both the Procedural Knowledge Graph and the LLM as supplementary input conditions for the procedure planning model, the learning and prediction processes become significantly more manageable for the model. This enables a reduction in reliance on extensive annotations from the dataset while maintaining effective planning capabilities, which improves performance and reduces computational resources.

The formulation of procedural plans is assisted by an AI agent, KEPP 106, in the realm of instructional videos. To enhance the agent's capabilities procedural knowledge is incorporated from procedure planning training videos, enabling the agent to adeptly handle the intricacies of step sequencing and its variations.

KEPP 106 employs a probabilistic procedural knowledge graph 206, sourced from these training videos, effectively serving as a ‘textbook’ for procedure planning. Experiments conducted on three datasets demonstrate that KEPP 106 delivers top-tier performance while necessitating only a minimal amount of supervision.

The training and inference of the AI agent, KEPP 106 provides the formulation of instructional videos using the guidance of a PKG and LLM(s) using AI. The AI models includes artificial neural networks (ANN), consisting of fully connected neurons to distinguish data in accordance with embodiments of the present invention to predict outputs or outcomes based on input data, e.g., image data. For example, the given and initial state and a goal state, a complete instructional video can be output using implementing a deep neural network trained from thousands, millions or more scenes or videos.

Given a set of input data, a machine learning system can predict an outcome, e.g., a best instructional video or a best sequence of steps. The machine learning system will likely have been trained on much training data in order to generate its model. It will then predict the best outcome based on the model.

In some embodiments, the artificial machine learning system includes an artificial neural network (ANN). One element of ANNs is the structure of the information processing system, which includes a large number of highly interconnected processing elements (called “neurons”) working in parallel to solve specific problems. ANNs are furthermore trained using a set of training data, with learning that involves adjustments to weights that exist between the neurons. An ANN is configured for a specific application, such as pattern recognition or data classification, through such a learning process.

The present embodiments may take any appropriate form, including any number of layers and any pattern or patterns of connections therebetween. ANNs demonstrate an ability to derive meaning from complicated or imprecise data and can be used to extract patterns and detect trends that are too complex to be detected by humans or other computer-based systems. The structure of a neural network is known generally to have input neurons that provide information to one or more “hidden” neurons. Connections between the input neurons and hidden neurons are weighted, and these weighted inputs are then processed by the hidden neurons according to some function in the hidden neurons. There can be any number of layers of hidden neurons, and as well as neurons that perform different functions. There exist different neural network structures as well, such as a convolutional neural network, a maxout network, etc., which may vary according to the structure and function of the hidden layers, as well as the pattern of weights between the layers. The individual layers may perform particular functions, and may include convolutional layers, pooling layers, fully connected layers, softmax layers, or any other appropriate type of neural network layer. A set of output neurons accepts and processes weighted input from the last set of hidden neurons.

This represents a “feed-forward” computation, where information propagates from input neurons to the output neurons. Upon completion of a feed-forward computation, the output is compared to a desired output available from training data. The error relative to the training data is then processed in “backpropagation” computation, where the hidden neurons and input neurons receive information regarding the error propagating backward from the output neurons. Once the backward error propagation has been completed, weight updates are performed, with the weighted connections being updated to account for the received error. It should be noted that the three modes of operation, feed forward, back propagation, and weight update, do not overlap with one another. This represents just one variety of ANN computation, and that any appropriate form of computation may be used instead. In the present case the output neurons provide emission information for a given plot of land provided from the input of satellite or other image data.

To train an ANN, training data can be divided into a training set and a testing set. The training data includes pairs of an input and a known output. During training, the inputs of the training set are fed into the ANN using feed-forward propagation. After each input, the output of the ANN is compared to the respective known output or target. Discrepancies between the output of the ANN and the known output that is associated with that particular input are used to generate an error value, which may be backpropagated through the ANN, after which the weight values of the ANN may be updated. This process continues until the pairs in the training set are exhausted.

After the training has been completed, the ANN may be tested against the testing set or target, to ensure that the training has not resulted in overfitting. If the ANN can generalize to new inputs, beyond those which it was already trained on, then it is ready for use. If the ANN does not accurately reproduce the known outputs of the testing set, then additional training data may be needed, or hyperparameters of the ANN may need to be adjusted.

ANNs may be implemented in software, hardware, or a combination of the two. For example, each weight may be characterized as a weight value that is stored in a computer memory, and the activation function of each neuron may be implemented by a computer processor. The weight value may store any appropriate data value, such as a real number, a binary value, or a value selected from a fixed number of possibilities, which is multiplied against the relevant neuron outputs. Alternatively, the weights may be implemented as resistive processing units (RPUs), generating a predictable current output when an input voltage is applied in accordance with a settable resistance.

A neural network becomes trained by exposure to empirical data. During training, the neural network stores and adjusts a plurality of weights that are applied to the incoming empirical data. By applying the adjusted weights to the data, the data can be identified as belonging to a particular predefined class from a set of classes or a probability that the input data belongs to each of the classes can be output.

The empirical data, also known as training data, from a set of examples can be formatted as a string of values and fed into the input of the neural network. Each example may be associated with a known result or output. Each example can be represented as a pair, (x, y), where x represents the input data and y represents the known output. The input data may include a variety of different data types, and may include multiple distinct values. The network can have one input node for each value making up the example's input data, and a separate weight can be applied to each input value. The input data can, for example, be formatted as a vector, an array, or a string depending on the architecture of the neural network being constructed and trained.

The neural network “learns” by comparing the neural network output generated from the input data to the known values of the examples, and adjusting the stored weights to minimize the differences between the output values and the known values. The adjustments may be made to the stored weights through back propagation, where the effect of the weights on the output values may be determined by calculating the mathematical gradient and adjusting the weights in a manner that shifts the output towards a minimum difference. This optimization, referred to as a gradient descent approach, is a non-limiting example of how training may be performed. A subset of examples with known values that were not used for training can be used to test and validate the accuracy of the neural network.

During operation, the trained neural network can be used on new data that was not previously used in training or validation through generalization. The adjusted weights of the neural network can be applied to the new data, where the weights estimate a function developed from the training examples. The parameters of the estimated function which are captured by the weights are based on statistical inference.

A deep neural network, such as a multilayer perceptron, can have an input layer of source nodes, one or more computation layer(s) having one or more computation nodes, and an output layer, where there is a single output node for each possible category into which the input example could be classified. An input layer can have a number of source nodes equal to the number of data values in the input data. The computation nodes in the computation layer(s) can also be referred to as hidden layers because they are between the source nodes and output node(s) and are not directly observed. Each node in a computation layer generates a linear combination of weighted values from the values output from the nodes in a previous layer, and applies a non-linear activation function that is differentiable over the range of the linear combination. The weights applied to the value from each previous node can be denoted, for example, by w₁, w₂, . . . wₙ₋₁, wₙ. The output layer provides the overall response of the network to the input data. A deep neural network can be fully connected, where each node in a computational layer is connected to all other nodes in the previous layer, or may have other configurations of connections between layers. If links between nodes are missing, the network is referred to as partially connected.

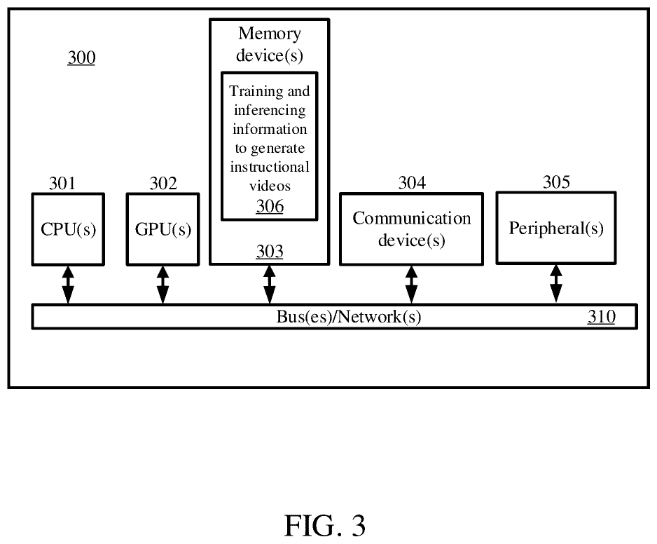

Referring to FIG. 3, a block diagram is shown for an exemplary processing system 300, in accordance with an embodiment of the present invention. The processing system 300 includes a set of processing units (e.g., CPUs) 301, a set of GPUs 302, a set of memory devices 303, a set of communication devices 304, and a set of peripherals 305. The CPUs 301 can be single or multi-core CPUs. The GPUs 302 can be single or multi-core GPUs. The one or more memory devices 303 can include caches, RAMs, ROMs, and other memories (flash, optical, magnetic, etc.). The communication devices 304 can include wireless and/or wired communication devices (e.g., network (e.g., WIFI, etc.) adapters, etc.). The peripherals 305 can include a display device, a user input device, a printer, an imaging device, and so forth. Elements of processing system 300 are connected by one or more buses or networks (collectively denoted by the figure reference numeral 310).

In an embodiment, memory devices 303 can store specially programmed software modules to transform the computer processing system into a special purpose computer configured to implement various aspects of the present invention. In an embodiment, special purpose hardware (e.g., Application Specific Integrated Circuits, Field Programmable Gate Arrays (FPGAs), and so forth) can be used to implement various aspects of the present invention.

In an embodiment, memory devices 303 store program code or software 306 for implementing one or more functions of the systems and methods described herein for training and inferencing information to configure and generate instructional videos including storing and employing artificial intelligence models. The memory devices 303 can store program code for implementing one or more functions of the systems and methods described herein.

Of course, the processing system 300 may also include other elements (not shown), as readily contemplated by one of skill in the art, as well as omitting certain elements. For example, various other input devices and/or output devices can be included in processing system 300, depending upon the particular implementation of the same, as readily understood by one of ordinary skill in the art. For example, various types of wireless and/or wired input and/or output devices can be used. Moreover, additional processors, controllers, memories, and so forth, in various configurations can also be utilized. These and other variations of the processing system 300 are readily contemplated by one of ordinary skill in the art given the teachings of the present invention provided herein.

Moreover, it is to be appreciated that various figures as described with respect to various elements and steps relating to the present invention that may be implemented, in whole or in part, by one or more of the elements of system 300.

Embodiments described herein may be entirely hardware, entirely software or including both hardware and software elements. In a preferred embodiment, the present invention is implemented in software, which includes but is not limited to firmware, resident software, microcode, etc.

Embodiments may include a computer program product accessible from a computer-usable or computer-readable medium providing program code for use by or in connection with a computer or any instruction execution system. A computer-usable or computer readable medium may include any apparatus that stores, communicates, propagates, or transports the program for use by or in connection with the instruction execution system, apparatus, or device. The medium can be magnetic, optical, electronic, electromagnetic, infrared, or semiconductor system (or apparatus or device) or a propagation medium. The medium may include a computer-readable storage medium such as a semiconductor or solid state memory, magnetic tape, a removable computer diskette, a random access memory (RAM), a read-only memory (ROM), a rigid magnetic disk and an optical disk, etc.

Each computer program may be tangibly stored in a machine-readable storage media or device (e.g., program memory or magnetic disk) readable by a general or special purpose programmable computer, for configuring and controlling operation of a computer when the storage media or device is read by the computer to perform the procedures described herein. The inventive system may also be considered to be embodied in a computer-readable storage medium, configured with a computer program, where the storage medium so configured causes a computer to operate in a specific and predefined manner to perform the functions described herein.

A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code to reduce the number of times code is retrieved from bulk storage during execution. Input/output or I/O devices (including but not limited to keyboards, displays, pointing devices, etc.) may be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

As employed herein, the term “hardware processor subsystem” or “hardware processor” can refer to a processor, memory, software or combinations thereof that cooperate to perform one or more specific tasks. In useful embodiments, the hardware processor subsystem can include one or more data processing elements (e.g., logic circuits, processing circuits, instruction execution devices, etc.). The one or more data processing elements can be included in a central processing unit, a graphics processing unit, and/or a separate processor- or computing element-based controller (e.g., logic gates, etc.). The hardware processor subsystem can include one or more on-board memories (e.g., caches, dedicated memory arrays, read only memory, etc.). In some embodiments, the hardware processor subsystem can include one or more memories that can be on or off board or that can be dedicated for use by the hardware processor subsystem (e.g., ROM, RAM, basic input/output system (BIOS), etc.).

In some embodiments, the hardware processor subsystem can include and execute one or more software elements. The one or more software elements can include an operating system and/or one or more applications and/or specific code to achieve a specified result.

In other embodiments, the hardware processor subsystem can include dedicated, specialized circuitry that performs one or more electronic processing functions to achieve a specified result. Such circuitry can include one or more application-specific integrated circuits (ASICs), field-programmable gate arrays (FPGAs), and/or programmable logic arrays (PLAs). These and other variations of a hardware processor subsystem are also contemplated in accordance with embodiments of the present invention.

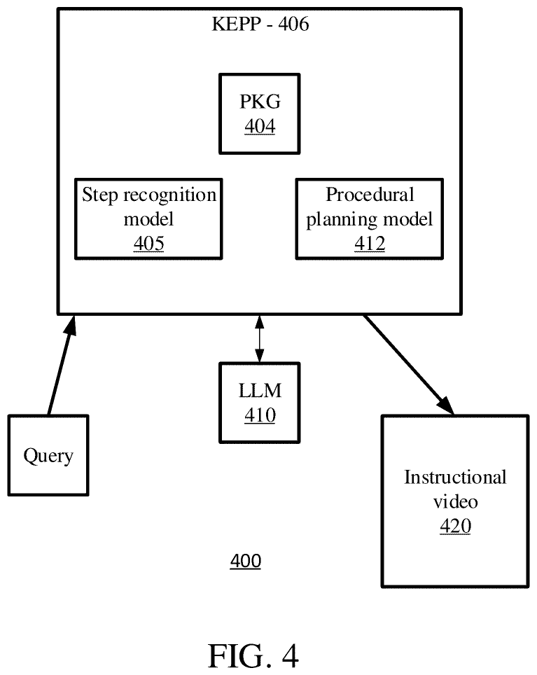

Referring to FIG. 4, in accordance with embodiments of the present invention, an instructional video system 402 is employed to generate instructional videos produced using the knowledge-enhanced procedure planning (KEPP) system 406. An initial visual observation and a goal visual state are obtained, which may be in the form of short video clips extracted from existing instructional videos. These clips may represent the starting point and desired outcome of the procedure to be demonstrated in the instructional video.

A procedural knowledge graph (PKG) 404 may be constructed using a set of training instructional videos. This PKG 404 may contain nodes representing various action steps within the instructional domain, with edges connecting these nodes to signify transitions between steps. The edges may also include information about the frequency and probability of these transitions based on real-world scenarios.

Using the initial visual observation and goal visual state as input, a step recognition model 405 may predict the first and last action steps of the procedure. This model may be trained on the set of training videos 202 to recognize and identify key steps in various procedures.

The system 402 may then query the PKG 404 to retrieve multiple procedural plans that start with the predicted first step and end with the predicted last step. These retrieved plans may serve as valuable suggestions for the overall procedure.

In some cases, the system may also employ a large language model (LLM) 410 to generate additional procedural plans. The LLM 410 may be prompted with the predicted first and last steps to produce alternative sequences of actions that could achieve the desired goal.

A procedure planning model 412 may then generate a comprehensive procedure plan using the retrieved procedural plans from the PKG 404 and, if applicable, the additional plans from the LLM 410. The procedure planning model 412 may take into account the initial visual observation, the goal visual state, and the various suggested plans to create a coherent and effective sequence of actions.

Based on the generated procedure plan, the system may output an instructional video 420. This video 420 may visually demonstrate the sequence of action steps that transition from the initial state to the goal state. The video 420 may include visual representations of each step, potentially augmented with textual descriptions or voice-over instructions to enhance clarity.

In some implementations, the system 402 may allow for user input or feedback to refine the generated instructional video 420. This may include adjusting the sequence of steps, adding more detailed explanations for certain actions, or incorporating alternative methods for achieving the same goal. The instructional video 420 may provide a clear, step-by-step guide for completing the desired task or procedure, leveraging the knowledge encoded in the PKG 404 and the broader understanding provided by the LLM 410 to create a comprehensive and effective learning tool.

In some embodiments, the instructional video 420 generated by the knowledge-enhanced procedure planning (KEPP) system 402 may include medical procedures, such as patient handling procedures or nursing tasks performed in a hospital setting. For example, the system 402 may be used to create an instructional video 420 on changing linens in a hospital bed while a patient is present.

The process may begin with an initial visual observation of a hospital bed with soiled linens and a goal visual state of a clean, properly made bed with a comfortable patient. The procedural knowledge graph (PKG) for this task may be constructed using a set of training videos demonstrating proper linen changing techniques in various hospital scenarios.

The step recognition model 405 may predict the first action step, such as explaining the procedure to the patient, and the last action step, such as ensuring the patient is comfortable in the freshly made bed. The system may then query the PKG 404 to retrieve multiple procedural plans that encompass the entire linen changing process.

In this medical context, the LLM 410 may be particularly useful in generating additional procedural plans that incorporate best practices for infection control, patient safety, and ergonomics for the nursing staff. The LLM 410 may suggest steps such as proper hand hygiene before and after the procedure, using appropriate personal protective equipment, and maintaining patient privacy throughout the process.

The procedure planning model may generate a comprehensive plan that includes steps such as:
1. Gathering necessary supplies
2. Explaining the procedure to the patient
3. Performing hand hygiene
4. Donning personal protective equipment
5. Lowering the bed and adjusting its position
6. Removing the soiled linens
7. Inspecting the mattress
8. Applying clean bottom sheet and drawsheet
9. Repositioning the patient
10. Applying clean top sheet and blanket
11. Ensuring proper alignment and tension of linens
12. Disposing of soiled linens properly
13. Removing personal protective equipment
14. Performing hand hygiene again
15. Adjusting bed to a comfortable position for the patient

The resulting instructional video 420 can visually demonstrate each of these steps, potentially including close-up shots of proper hand hygiene techniques or the correct way to tuck in corners of sheets. The instructional video 420 may also include textual overlays highlighting key points or potential risks to be aware of during the procedure.

In some cases, a system 400 may incorporate additional medical considerations into the instructional video 420. For example, it may include variations of the procedure for patients with specific medical conditions, mobility issues, or attached medical equipment. The instructional video 420 may also emphasize the importance of assessing the patient's condition throughout the procedure and communicating effectively with the patient.

By leveraging the knowledge encoded in the PKG 404 and the broader medical understanding provided by the LLM 410, the KEPP system 406 may create a comprehensive and effective instructional video 420 for this nursing task. Such videos may be valuable tools for training new nursing staff, refreshing the skills of experienced nurses, or standardizing procedures across different hospital units or healthcare facilities.

In addition to medical procedures, the knowledge-enhanced procedure planning (KEPP) system 406 may be used to generate instructional videos for a wide range of tasks and domains. Some examples of other instructional videos that could be created using this system 402 can include, e.g., cooking and food preparation (videos demonstrating recipes, cooking techniques, food safety procedures, etc.); home maintenance and repair (tutorials on tasks such as fixing a leaky faucet, unclogging a drain, or painting a room, etc.), automotive maintenance (step-by-step guides for changing oil, replacing brake pads, performing basic car diagnostics, etc.). technology tutorials (instructions for setting up new devices, troubleshooting common issues, or using specific software applications, etc.); fitness and exercise (workout routines, proper form for various exercises, rehabilitation techniques for injuries, etc.); arts and crafts (guides for creating various art projects, such as knitting, painting, woodworking, etc.); gardening and landscaping (videos on planting, pruning, pest control, landscape design, etc.); and any other procedural task or tasks.

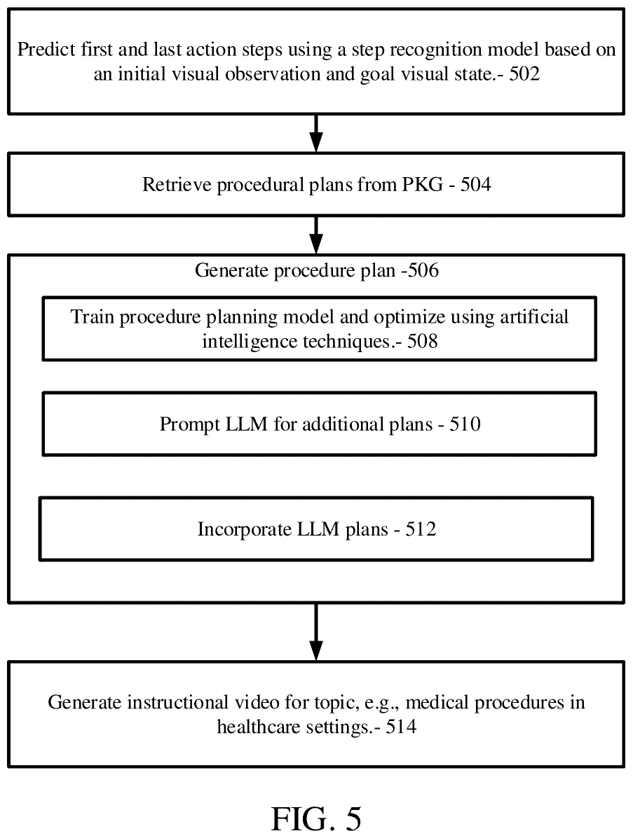

Referring to FIG. 5, computer-implemented methods are shown and described in accordance with embodiments of the present invention. In block 502, a first action step and a last action step are predicted based on an initial visual observation and a goal visual state. This can include using a step recognition model trained on the set of training instructional videos.

In block 504, multiple procedural plans are retrieved from a procedural knowledge graph (PKG), trained using a set of training instructional videos, which start with the first action step and end with the last action step. The PKG includes action steps represented as nodes and edges representing transitions between action steps. The edges can include transition probabilities between action steps.

In block 506, a procedure plan is generated using the retrieved procedural plans. The procedure plan can include using a procedure planning model that takes as input the initial visual observation, the goal visual state, and the retrieved procedural plans. In block 508, the procedure planning model can be trained using annotated action steps from the training instructional videos as supervision signals. The procedure plan can be generated using artificial intelligence techniques to optimize the sequence of action steps.

In block 510, a large language model (LLM) can be prompted with the predicted first action step and last action step to generate additional procedural plans. In block 512, the additional procedural plans from the LLM can be incorporated in generating the procedure plan.

In block 514, an instructional video is generated based on the procedure plan. The instructional video includes a sequence of action steps for transitioning from the initial visual observation to the goal visual state. The instructional video can include a sequence of action steps for transitioning from the initial visual observation to the goal visual state. The instructional video can be generated for a medical procedure in a healthcare setting or any other procedural task. The instructional video can be employed by a user to properly perform the procedure.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment. However, it is to be appreciated that features of one or more embodiments can be combined given the teachings of the present invention provided herein.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended for as many items listed.

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the present invention and that those skilled in the art may implement various modifications without departing from the scope and spirit of the invention. Those skilled in the art could implement various other feature combinations without departing from the scope and spirit of the invention. Having thus described aspects of the invention, with the details and particularity required by the patent laws, what is claimed and desired protected by Letters Patent is set forth in the appended claims.

What is claimed is:

1. A computer-implemented method, comprising:
predicting a first action step and a last action step based on an initial visual observation and a goal visual state;
retrieving multiple procedural plans from a procedural knowledge graph (PKG), trained using a set of training instructional videos, which start with the first action step and end with the last action step;
generating a procedure plan using the multiple procedural plans; and
generating an instructional video based on the procedure plan.

2. The method of claim 1, wherein the PKG includes action steps represented as nodes; and edges representing transitions between action steps.

3. The method of claim 2, wherein the edges include transition probabilities between action steps.

4. The method of claim 1, wherein predicting the first action step and the last action step includes using a step recognition model trained on the set of training instructional videos.

5. The method of claim 1, further comprising:
prompting a large language model (LLM) with the first action step and last action step to generate additional procedural plans; and
incorporating the additional procedural plans from the LLM in generating the procedure plan.

6. The method of claim 1, wherein generating the procedure plan includes using a procedure planning model that takes as input the initial visual observation, the goal visual state, and the multiple procedural plans.

7. The method of claim 6, further comprising training the procedure planning model using annotated action steps from the training of instructional videos as supervision signals.

8. The method of claim 1, wherein the instructional video includes a sequence of action steps for transitioning from the initial visual observation to the goal visual state.

9. The method of claim 1, wherein the instructional video includes a sequence of action steps for transitioning from the initial visual observation to the goal visual state.

10. The method of claim 1, wherein generating the procedure plan includes using artificial intelligence techniques to optimize a sequence of action steps.

11. The method of claim 1, wherein the instructional video is generated for a medical procedure in a healthcare setting.

12. A system, comprising:
a memory storing instructions; and
a processor configured to execute the instructions to:
access a procedural knowledge graph (PKG) constructed using a set of training instructional videos;
predict a first action step and a last action step based on an initial visual observation and a goal visual state;
retrieve multiple procedural plans from the PKG that start with the first action step and end with the last action step;
generate a procedure plan using the multiple procedural plans retrieved from the PKG; and
generate an instructional video based on the procedure plan.

13. The system of claim 12, wherein the PKG includes:
nodes representing action steps extracted from training instructional videos; and
edges connecting the nodes, the edges representing transitions between action steps and including transition probabilities between action steps.

14. The system of claim 12, wherein the processor is further configured to execute the instructions to predict the first action step and the last action step using a step recognition model trained on a set of training instructional videos.

15. The system of claim 12, wherein the processor is further configured to execute the instructions to:
prompt a large language model (LLM) with the first action step and last action step to generate additional procedural plans; and
incorporate the additional procedural plans from the LLM in generating the procedure plan.

16. The system of claim 12, further comprising: a procedure planning model that takes as input the initial visual observation, the goal visual state, and the multiple procedural plans.

17. The system of claim 16, wherein the processor is further configured to execute the instructions to train the procedure planning model using annotated action steps from training instructional videos as supervision signals.

18. The system of claim 12, wherein the instructional video includes a sequence of action steps for transitioning from the initial visual observation to the goal visual state.

19. The system of claim 12, wherein the procedure plan is generated using artificial intelligence techniques to optimize a sequence of action steps.

20. The system of claim 12, wherein the instructional video is generated for a medical procedure in a healthcare setting.
